(19) United States
(12) Patent Application Publication
(10) Pub. No.: US 2026/0127627 A1
(43) Pub. Date: May 7, 2026

(54) METHOD OF PROVIDING PRODUCT PRICE PREDICTION SERVICE AND SERVER FOR PERFORMING SAME

(71) Applicant: NATURE MOBILITY CO., LTD., Jeju-si Jeju-do (KR)

(72) Inventors: Ju Sang LEE, Seoul (KR); Ouk Seh LEE, Chungcheongbuk-do (KR)

(73) Assignee: NATURE MOBILITY CO., LTD., Jeju-si Jeju-do (KR)

(21) Appl. No.: 19/114,423

(22) PCT Filed: Nov. 8, 2023
(86) PCT No.: PCT/KR2023/017842

§ 371 Date: Mar. 21, 2025

(30) Foreign Application Priority Data
Nov. 14, 2022 (KR) 10-2022-0152056

(51) Int. Cl. G06Q 30/0201; G06Q 30/0202

(52) U.S. Cl. CPC G06Q 30/0206; G06Q 30/0202

(57) ABSTRACT

The present invention relates to a product price prediction method performed by a processor of a price prediction server, and the method comprises the steps of: receiving price inquiry data of a product from a customer device via a communication interface operably connected to the processor; generating multiple pieces of product condition data on the basis of multiple features predetermined for the product by using the price inquiry data; predicting a sales price per purchase date by inputting the multiple pieces of product condition data to a price prediction model that is trained to predict the sales price of a product per purchase date by using product condition data as an input; and providing, to the customer device, a price prediction service interface screen obtained by visualizing the sales price of the product into a graph over purchase dates.

### TECHNICAL FIELD

This invention relates to a method of providing service for estimating commodity prices and a server for performing the same.

### BACKGROUND ART

For intangible commodities with significant temporal demand variations, the sales prices are not fixed and show large price fluctuations. For example, travel products experience dramatic demand changes between peak and off-peak seasons, weekends and holidays, and show large demand variations by region, which inevitably leads to significant price fluctuations.

Typically, commodities with large price fluctuations based on demand are cheaper when purchased in advance. However, if future reservation rates (purchase rates) are low, sellers may lower the sales price of products. Consequently, unless consumers observe market prices for an extended period, it is difficult for them to determine whether the product they want to purchase is reasonably priced or if the current purchase timing is appropriate.

Meanwhile, sellers need to continuously monitor competitors' sales prices to set competitive pricing. However, as product offerings diversify and the number of competitors increases, setting competitive sales prices requires significant time and cost.

The background technology described here is intended to facilitate understanding of this invention. It should not be interpreted that matters stated in the background technology are acknowledged as prior art.

### DETAILED DESCRIPTION OF THE INVENTION

### Technical Problem

Conventional price comparison services that compare sellers' sales prices have been provided. Since conventional price comparison services only provide the lowest current price, both consumers who purchase products in advance and sellers may risk financial losses.

Therefore, a new price prediction service that forecasts future prices for product groups with high price volatility is required.

As a result, the inventors of this invention sought to develop a method and server that can predict product sales prices by identifying factors affecting product sales prices, primarily peak season, off-peak season, and holiday information, and by refining customer (hereinafter referred to as “client”) price query data accordingly.

In particular, the inventors of this invention sought to develop a method and server that can more accurately predict sales prices matching various conditions set by customers and sellers by learning product sales prices based on factors that influence them, while learning them as independent variables so they do not affect each other.

Additionally, the inventors structured the method to provide an intuitive at-a-glance view of current and future prices by combining two types of graphs into a single price fluctuation graph in the product price prediction service interface screen.

The objectives of this invention are not limited to those mentioned above, and other unmentioned objectives will be clearly understood by those skilled in the art from the following description.

### Technical Solution

To solve the aforementioned problems, according to one embodiment of this invention, a method of providing product price prediction service is provided. The method, performed by a processor of a price prediction server, comprises: receiving price query data for a product from a customer device through a communication interface operatively connected to the processor; generating multiple product condition data based on predetermined multiple features for the product from the price query data; predicting sales prices by date of purchase by inputting the multiple product condition data into a price prediction model trained to predict product sales prices by purchase date using product condition data as input; and providing the customer device with a price prediction service interface screen that visualizes the product's sales prices graphically by purchase date.

According to one feature of this invention, the price query data may include at least one of: product identification information, product purchasable dates, usage start date, usage end date, usage time, and product type-specific options.

According to another feature of this invention, the generating step may further include converting the query date and usage start date included in the price query data into data including usage year, usage week number of the year, usage day of week, day before holiday, holiday duration, day after holiday, and advance purchase days, according to the product type.

According to another feature of this invention, the price prediction service interface screen may be configured to display changes in sales prices by purchase date as a line graph for the period from the current time when the price query data was received until before the purchasable time.

According to another feature of this invention, the price prediction service interface screen may be configured to display the case of purchasing the product at the current time as a reference point for the sales price, and display the range of predicted future sales prices by date until the usage start time as a bar graph on the reference point.

According to another feature of this invention, the price prediction service interface screen may be configured to display price changes with multiple product condition data selectively applied according to the product type.

According to another feature of this invention, the multiple features may include at least one of: customer inquiry date, usage date/time, usage location, product type, seller type, and customer rating data.

According to another feature of this invention, when one type of product condition data includes at least two options, the price prediction model may be separately learned into first, second, and third price prediction models using a first product condition dataset containing only one option, a second product condition dataset containing only the other option, and a third product condition dataset containing none of the options.

To solve the aforementioned problems, according to another embodiment of this invention, a price prediction server is provided. The server includes a communication interface, memory, and a processor operatively connected to the communication interface and memory, wherein the processor is configured to: receive price query data for a product from a customer device through the communication interface; generate multiple product condition data based on predetermined multiple features for the product from the price query data; predict sales prices by date of purchase by inputting the multiple product condition data into a price prediction model trained to predict product sales prices by purchase date using product condition data as input; and provide the customer device with a price prediction service interface screen that visualizes the product's sales prices graphically by purchase date.

Other implementation details are included in the detailed description and drawings.

### Effects of the Invention

This invention can help customers (consumers) make rational product purchases. Specifically, for products with volatile pricing where consumer prices are not fixed, this invention can help customers make rational purchases and stimulate consumption by providing predicted sales prices by purchase date.

Additionally, through the price prediction service interface, this invention can help customers easily select product options (conditions) by providing different sales price graphs for each product condition.

Furthermore, by providing predicted sales prices by purchase date, this invention can help sellers establish appropriate sales plans (e.g., seasonal promotions). Specifically, this invention can secure profits by adjusting sales prices according to times/dates with high price volatility.

Moreover, this invention can increase market transparency by providing current sales prices and predicted future sales prices not only to sellers but also to customers.

Additionally, this invention can help sellers gain market dominance by securing price competitiveness through predicting sales prices for products with high price volatility.

The effects of this invention are not limited to the examples described above, and more diverse effects are included within this invention.

### BRIEF DESCRIPTION OF DRAWINGS

FIG. 1 is a schematic diagram of a product price prediction service according to one embodiment of this invention.

FIG. 2 is a schematic diagram of a product price prediction service provision system according to one embodiment of this invention.

FIG. 3 is a block diagram showing the configuration of a price prediction server according to one embodiment of this invention.

FIG. 4 is a schematic flowchart of a method of providing product price prediction service according to one embodiment of this invention.

FIG. 5a and FIG. 5b are schematic diagrams for explaining the price prediction model according to one embodiment of this invention.

FIG. 6 is an exemplary view of a price prediction service interface screen provided through customer devices and seller devices according to one embodiment of this invention.

FIG. 7 is a block diagram showing the configuration of a customer device according to one embodiment of this invention.

### MODES OF THE INVENTION

The advantages and features of this invention, and methods to achieve them will become more apparent from the following detailed description of embodiments with reference to the accompanying drawings. However, this invention is not limited to the embodiments disclosed herein but may be implemented in various different forms. These embodiments are provided to make the disclosure complete and to fully convey the scope of the invention to those skilled in the art. The invention is only defined by the scope of the claims.

In this document, expressions “has,” “may have,” “includes,” or “may include” indicate the existence of a corresponding feature (e.g., numerical value, function, operation, or component) but do not exclude the possibility of additional features.

In this document, expressions “A or B,” “at least one of A or/and B,” or “one or more of A or/and B” may include all possible combinations of items listed together. For example, “A or B,” “at least one of A and B,” or “at least one of A or B” may include (1) including at least one A, (2) including at least one B, or (3) including both at least one A and at least one B.

Expressions “first,” “second,” etc. used in this document may modify various components regardless of order and/or importance and are used merely to distinguish one component from another. They do not limit the corresponding components. For example, a first user device and a second user device may indicate different user devices regardless of order or importance. Without departing from the scope of this document, a first component may be referred to as a second component, and similarly, a second component may be referred to as a first component.

When a component is “operatively or communicatively coupled with/to” or “connected to” another component, it should be understood that the component may be directly connected to the other component or connected through another component (e.g., a third component). Conversely, when a component is “directly connected to” or “directly coupled to” another component, it should be understood that there are no other components between the two components.

In this document, the expression “configured (or set) to” may be interchangeably used with “suitable for,” “having the capacity to,” “designed to,” “adapted to,” “made to,” or “capable of” depending on circumstances. The term “configured (or set) to” does not necessarily mean “specifically designed to” in hardware. Instead, in some situations, the expression “device configured to” may mean that the device can achieve this with other devices or parts. For example, the phrase “processor configured (or set) to perform A, B, and C” may mean a dedicated processor (e.g., embedded processor) for performing the corresponding operations or a generic-purpose processor (e.g., CPU or application processor) that can perform the corresponding operations by executing one or more software programs stored in a memory device.

Terms used in this document are used to describe specific embodiments and are not intended to limit the scope of other embodiments. Unless explicitly described otherwise, terms in singular form may include plural forms. Technical or scientific terms used here shall have the same meanings that are generally understood by those skilled in the art unless explicitly defined otherwise. Terms defined in general dictionaries shall be interpreted to have the same or similar meanings in the context of related technology unless explicitly defined otherwise in this document.

The various embodiments of this invention may be partially or wholly combined with each other and may be interlocked and driven in various technically possible ways, as fully understood by those skilled in the art, and may be independently implemented or implemented in an associated relationship.

Hereinafter, preferred embodiments of this invention will be described in detail with reference to the accompanying drawings.

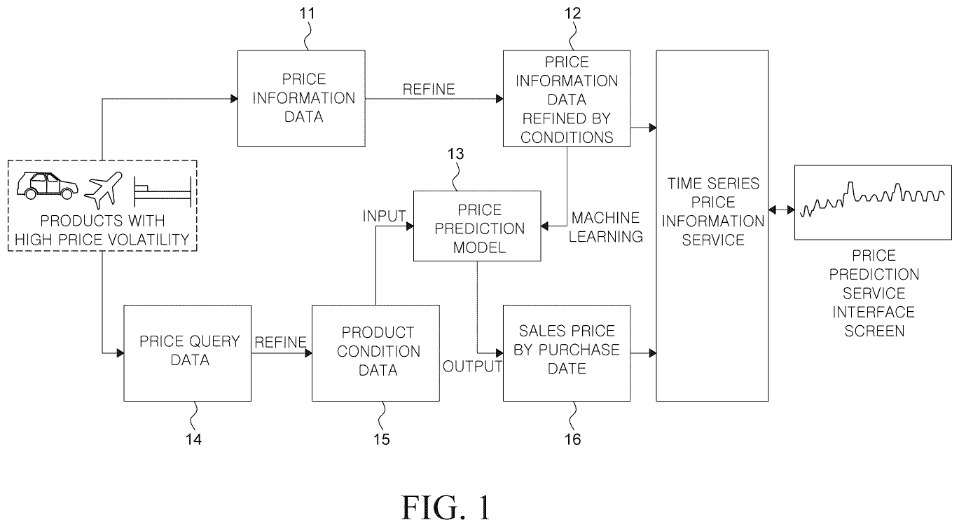

FIG. 1 is a schematic diagram of a product price prediction service according to one embodiment of this invention.

Referring to FIG. 1, the product price prediction service according to one embodiment of this invention can predict and provide sales prices for product groups with large price fluctuations through a price prediction model. Here, product groups with large price fluctuations refer to product groups that show significant price variations compared to regular prices due to various price fluctuation factors such as season, region, and usage period, and particularly refer to product groups with fixed usage start dates. Representative examples may include rental cars, airline tickets, and accommodation reservations. However, the price prediction method according to one embodiment of this invention is not limited to the aforementioned product groups, and various goods and services can be applied to this invention.

The price prediction model 13 used to predict product sales prices can be machine-learned based on price information data 11. Specifically, the price prediction server 100 providing the price prediction service can acquire price information data 11 from customers and sellers, and can refine it by conditions. Here, conditions are factors that influence product sales prices, and the price prediction server 100 can separately learn the price information data 12 refined by conditions. However, more detailed explanation will be provided later. The price prediction server 100 can generate a price prediction model 13 that can output sales prices by purchase date using the price information data 12 refined by conditions as input.

In other words, when the price prediction server 100 receives price query data 14 from a customer, it can generate multiple product condition data 15 by refining the price query data 14 according to conditions. Then, it can output prediction results of sales prices 16 by purchase date for the product desired by the customer by inputting the multiple product condition data 15 into the price prediction model 13. These prediction results can be filtered by various conditions applied to the product and displayed, and the price prediction server 100 can provide a price prediction service interface screen allowing customers to grasp this at a glance.

Up to now, the product price prediction service according to one embodiment of this invention has been broadly explained. Below, the price prediction service provision system will be explained.

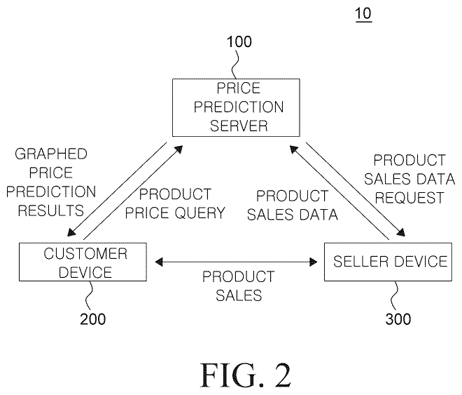

FIG. 2 is a schematic diagram of a product price prediction service provision system according to one embodiment of this invention.

Referring to FIG. 2, the product price prediction service provision system 10 (hereinafter referred to as “price prediction system”) may include a price prediction server 100, a customer device 200, and a seller device 300.

The price prediction server 100 is an electronic device that provides a service predicting sales prices by purchase date according to customer or seller requests, and may include various electronic devices such as PCs, tablet PCs, data servers, etc.

The price prediction server 100 can provide an interface screen visualizing the price prediction service, and accordingly, the price prediction server 100 can provide web/mobile applications for price prediction service to customer devices 200 and seller devices 300. Here, the web/mobile applications can be installed and executed on customer devices 200 and seller devices 300, or can be executed without separate installation through URLs, image codes, etc.

The price prediction server 100 can request product sales data from seller devices 300 and acquire product sales data. However, the price prediction server 100 can similarly acquire product sales data from customer devices 100. The price prediction server 100 can generate multiple product condition data by refining product sales data by conditions. For example, in the case of rental car products, product sales data may include product identification information such as car type, product purchase date, product usage start date, usage end date, usage time, and product type-specific options like black box, final purchase price, etc.

The price prediction server 100 can generate a price prediction model by learning the product sales data refined by conditions. For example, the price prediction server 100 can generate a price prediction model using commonly known technologies such as LGBM (light gradient boosting model), XGB (extreme gradient boosting model), which are decision tree-based learning algorithms, or multi-layer perceptron, which is a neural network-based learning algorithm. To improve prediction accuracy, the price prediction server 100 can learn data refined by conditions separately, and detailed explanation will be provided later.

When receiving a product price inquiry from customer device 200, the price prediction server 100 can predict product sales prices by purchase date based on the learned price prediction model and provide customer device 200 with graphed price prediction results.

Meanwhile, since such price prediction results are necessary information for price setting not only for customers purchasing products but also from sellers' perspective, the price prediction server 100 can similarly provide price prediction results for products to seller devices 300.

Customer device 200 is a device possessed by customers wanting to purchase products and can include various communicable electronic devices such as smartphones, tablet PCs, PCs, laptops, etc. Customer device 200 can use the product sales price prediction service through web/mobile applications provided by price prediction server 100.

Seller device 300 is a device possessed by sellers wanting to sell products and can include various communicable electronic devices such as smartphones, tablet PCs, PCs, laptops, etc. Seller device 300 can provide product sales prices by date and time to price prediction server 100, and can use the product sales price prediction service through web/mobile applications provided by price prediction server 100.

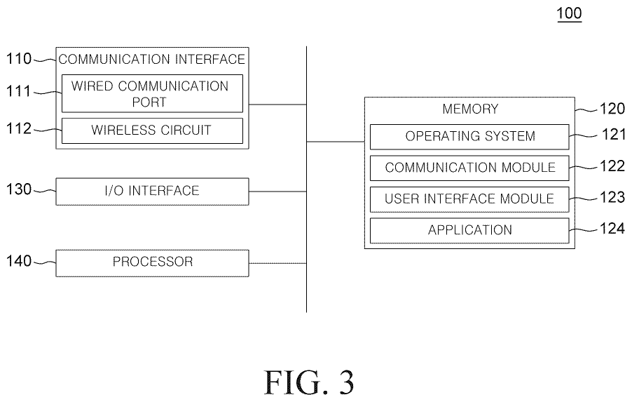

Up to now, the price prediction system 10 according to one embodiment of this invention has been explained, and below, referring to FIG. 3 through FIG. 6, the price prediction server 100 providing such price prediction service will be explained in more detail.

FIG. 3 is a block diagram showing the configuration of a price prediction server according to one embodiment of this invention.

Referring to FIG. 3, price prediction server 100 may include communication interface 110, memory 120, I/O interface 130, and processor 140, and each component can communicate with each other through one or more communication buses or signal lines.

Communication interface 110 can exchange data with customer device 200 and seller device 300 through wired/wireless communication networks. For example, communication interface 110 can receive price query data, i.e., price prediction service requests for products from customer device 200, and transmit graphs of predicted sales prices by purchase date to customer device 200. In another example, communication interface 110 can receive product sales data including product conditions, sales dates, prices, events, etc. from seller device 300, and transmit graphs of predicted sales prices by purchase date according to seller device 300's request.

Meanwhile, communication interface 110, which enables such data transmission and reception, includes wired communication port 311 and wireless circuit 312, where wired communication port 311 can include one or more wired interfaces, for example, Ethernet, Universal Serial Bus (USB), FireWire, etc. Additionally, wireless circuit 312 can transmit and receive data with external devices through RF signals or optical signals. Furthermore, wireless communication can use at least one of multiple communication standards, protocols and technologies, such as GSM, EDGE, CDMA, TDMA, Bluetooth, Wi-Fi, VoIP, Wi-MAX, or any other suitable communication protocol.

Memory 120 can store various data used in the price prediction server 100. For example, memory 120 can store product sales data including product conditions, sales dates, prices, events, etc., and price prediction models machine-learned by product sales conditions.

In various embodiments, memory 120 can include volatile or non-volatile recording media capable of storing various data, commands, and information. For example, memory 120 can include storage media of at least one type among flash memory type, hard disk type, multimedia card micro type, card type memory (e.g., SD or XD memory), RAM, SRAM, ROM, EEPROM, PROM, network storage, cloud, blockchain database.

In various embodiments, memory 120 can store at least one component among operating system 121, communication module 122, user interface module 123, and one or more applications 124.

Operating system 121 (e.g., LINUX, UNIX, MAC OS, WINDOWS, VxWorks, etc.) can include various software components and drivers for controlling general system tasks (e.g., memory management, storage device control, power management, etc.) and can support communication between various hardware, firmware, and software components.

Communication module 122 can support communication with other devices through communication interface 110. Communication module 122 can include various software components for processing data received by wired communication port 111 or wireless circuit 112 of communication interface 110.

User interface module 123 can receive user requests or inputs through I/O interface 130 from keyboard, touch screen, keyboard, mouse, microphone, etc., and provide user interfaces on the display.

Application 124 can include programs or modules configured to be executed by one or more processors 140. Here, applications for predicting product prices can be implemented on a server farm.

I/O interface 130 can connect input/output devices (not shown) of price prediction server 100, such as display, keyboard, touch screen, and microphone, with user interface module 123. I/O interface 130 can receive user inputs (e.g., voice input, keyboard input, touch input, etc.) together with user interface module 123 and process commands according to received inputs.

Processor 140 is connected to communication interface 110, memory 120, and I/O interface 130 and can control the overall operation of price prediction server 100, and can execute various commands to provide price prediction service to customers and sellers through applications or programs stored in memory 120.

Processor 140 can correspond to computing devices such as CPU (Central Processing Unit) or AP (Application Processor). Also, processor 140 can be implemented in the form of an integrated chip (IC) such as SoC (System on Chip) which integrates various computing devices. Or processor 140 can include modules for calculating artificial neural network models such as NPU (Neural Processing Unit).

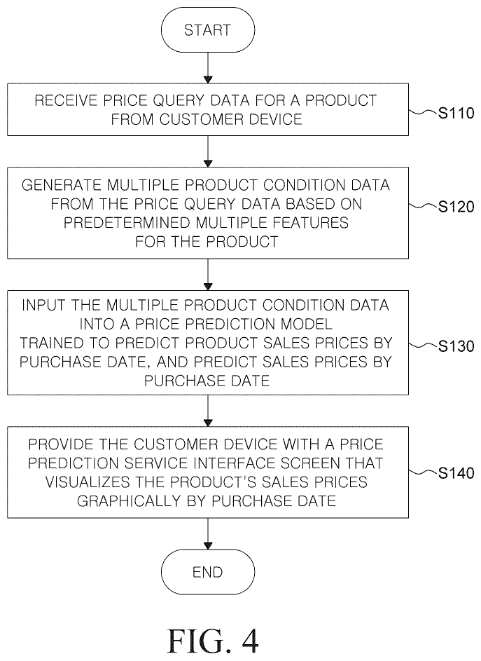

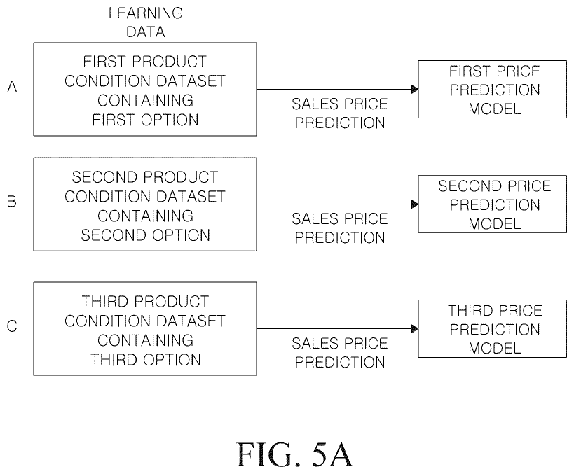

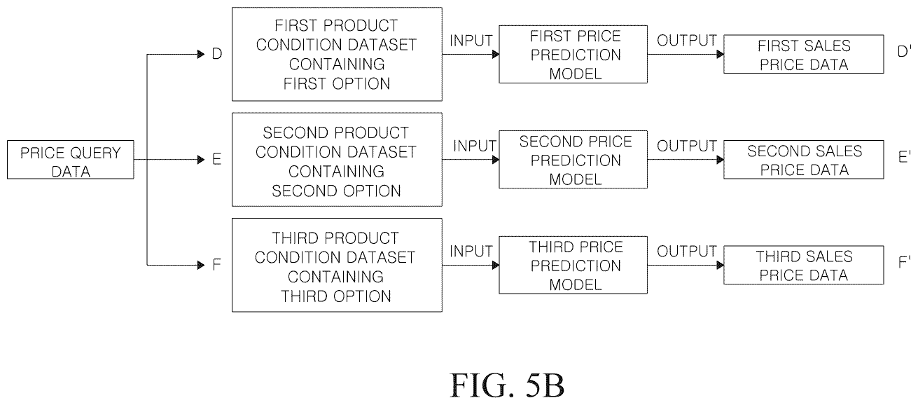

Below, referring to FIG. 4 through FIG. 5f, the method of processor 140 of price prediction server 100 providing a user interface that visualizes product sales price ranges by purchase date in graphs will be explained.

FIG. 4 is a schematic flowchart of a product price prediction service provision method according to one embodiment of this invention.

Referring to FIG. 4, processor 140 can receive price query data for a product from customer device 200 through communication interface 110 (S110). Specifically, processor 140 can receive price query data including at least one of product identification information, product purchasable dates, usage start date, usage end date, usage time, and product type-specific options.

In various embodiments, processor 140 can provide a query data acquisition interface screen to customer device 200 to request these data (product identification information, product purchasable dates, usage start date, usage end date, usage time, and product type-specific options, etc.).

After step S110, processor 140 can generate multiple product condition data from the price query data based on predetermined multiple features for the product (S120). The predetermined multiple features for the product refer to factors that influence product sales prices. Specifically, the multiple features can include at least one data among customer inquiry date, usage date/time, usage location, product type, seller type, and customer rating data. Processor 140 can generate multiple product condition data by refining price query data to match each feature. For example, representative products with high price volatility like rental cars, airline tickets, and accommodation reservations can have multiple features predetermined as shown in Tables 1, 2, and 3 below, and processor 140 can generate product condition data based on each feature according to the methods defined in Tables 1, 2, and 3. However, this is just an example to help understand the invention, and factors affecting product sales prices can be added/deleted by product. Specifically, among the features, usage year, usage week number, usage day of week, day before holiday, holiday, day after holiday, and advance purchase days related to usage date and purchase date are common features that affect prices of products with high price volatility. Other features are just examples to help understand the invention, and factors affecting product sales prices can be added/deleted by product.

TABLE 1

| Product Features | Product Condition Data Generation Method |
|---|---|
| Usage year | Convert usage date recorded in month, day units into ISO |
| Usage week number | calendar in ‘week number’ units |
| Usage day of week | Week number calculated as which week of the year |
| Day before holiday | Holiday means 2 or more days (including weekends) |
| Holiday | Each item encoded as holiday length |
| Day after holiday | (e.g., when 5-day holiday starts tomorrow, day before |
| | holiday = 5, holiday = 0, day after holiday = 0) |
| Advance purchase | Difference between collection date (=purchase date) and |
| days | usage date |
| Vehicle grade | Grade (compact, small, semi-medium, medium, luxury, |
| Vehicle | RV/SUV, van) |
| manufacturer | Manufacturer (Hyundai, Kia, Renault Samsung, Ssangyong, |
| Fuel type | GM, Import) |
| Engine size | Fuel type (gasoline, diesel, LPG, electric, hybrid) |
| Number of seats | Engine size (engine capacity cc, *price for electric vehicles) |
| Vehicle year | |
| Company size | Number of vehicles owned by company (n) > [log₁₀n] |
| Insurance type | No insurance, basic, full coverage, super |
| Region | Rental region (city, province, etc.) |

TABLE 2

| Product Features | Product Condition Data Generation Method |
|---|---|
| Usage year | Convert usage date recorded in month, day units into ISO |
| Usage week number | calendar in ‘week number’ units |
| Usage day of week | Week number calculated as which week of the year |
| Day before holiday | Holiday means 2 or more days (including weekends) |
| Holiday | Each item encoded as holiday length (e.g., when 5-day |
| Day after holiday | holiday starts tomorrow, day before holiday = 5, holiday = 0, |
| | day after holiday = 0) |
| Advance purchase | Difference between collection date (=purchase date) and |
| days | usage date |
| Departure airport | Departure airport (domestic civilian airports) and arrival |
| Arrival airport | airport |
| Distance | Distance between airports (km) |
| Departure time | Departure time (e.g., hour units) |
| Flight time | Flight time (e.g., 10-minute units) |

TABLE 3

| Product Features | Product Condition Data Generation Method |
|---|---|
| Usage year | Convert usage date recorded in month, day units into ISO |
| Usage week number | calendar in ‘week number’ units |
| Usage day of week | Week number calculated as which week of the year |
| Day before holiday | Holiday means 2 or more days (including weekends) |
| Holiday | Each item encoded as holiday length (e.g., when 5-day |
| Day after holiday | holiday starts tomorrow, day before holiday = 5, holiday = 0, |
| | day after holiday = 0) |
| Advance purchase | Difference between collection date (=purchase date) and |
| days | usage date |
| Hotel latitude | Hotel information |
| Hotel longitude | Location information expressed in latitude/longitude |
| Hotel grade | Grade (star rating basis) |
| Hotel type | Hotels other than grade (e.g., hotel, guesthouse, resort, |
| | hostel, pension, apartment, motel, villa, homestay, chalet, |
| | etc.) |
| User rating | Customer evaluation information |
| Number of reviews | |

At this time, processor 140 can convert the product usage start date included in the price query data into units of month, day, week, and day of week according to the product type. Specifically, for rental car products that have peak and off-peak seasons, “week number” unit distinction may be used for more precise sales price prediction rather than month and day unit distinction. Accordingly, for example, when processor 140 receives price query data containing “February 28˜”, it can convert this to “9th week of 2022”.

In various embodiments, processor 140 can convert the query date and usage start date included in the product price query data into data including usage year, usage week number of the year, usage day of week, day before holiday, holiday duration, day after holiday, and advance purchase days. That is, processor 140 can generate product condition data as a set of numbers for features of inquiry date and usage date/time from the price query data.

For example, if processor 140 acquires price query data on Feb. 20, 2022, inquiring about rental car prices for use on Feb. 28, 2022, it can generate product condition data [2022, 9, 1, 0, 4, 0, 8]. Here, “9, 1” means the first day (Monday) of the 9th week of 2022, “0” means no holiday of 2 or more days is included before the usage date, “4” means it's during a 4-day holiday, “0” means it's not the day after a holiday of 2 or more days, and “8” means the purchase query was received 8 days in advance.

After step S120, processor 140 can predict sales prices by purchase date by inputting the multiple product condition data into a price prediction model trained to predict product sales prices by purchase date using product condition data as input (S130). Specifically, sales prices by purchase date can be understood as daily sales prices during the period from the current time when the price query data was received until before the purchasable time.

Meanwhile, the price prediction model may be a model separately trained with data refined by conditions to improve sales price prediction accuracy. That is, when one type of product condition data includes at least two options, the price prediction model can learn each option separately.

In relation to this, FIG. 5a and FIG. 5b are schematic diagrams for explaining the price prediction model according to one embodiment of this invention.

Referring to FIG. 5a, when sales price patterns differ according to options (product conditions), processor 140 can learn price prediction models by separating data by product options. For example, in the case of rental car products, sales price patterns may differ depending on whether the rental car reservation region is “Jeju region” or “mainland region”. In another example, for airline tickets, sales price patterns may differ according to options like “Gimpo departure-Jeju arrival”, “Jeju departure-Gimpo arrival” and “other flights”.

That is, processor 140 can separately learn first, second, and third price prediction models using first product condition dataset A containing only the first option, second product condition dataset B containing only the second option without satisfying the first option, and third product condition dataset C containing none of the options.

Referring to FIG. 5b, processor 140 can check if there exists any price condition data among multiple price condition data generated in step S120 that has two or more prediction models. Accordingly, processor 140 can input the corresponding price condition data into one of the first, second, or third price prediction models depending on whether it contains one of the first, second, or third options, and output corresponding sales price data.

After step S130, processor 140 can provide customer device 200 with a price prediction service interface screen that visualizes the product's sales prices graphically by purchase date (S140).

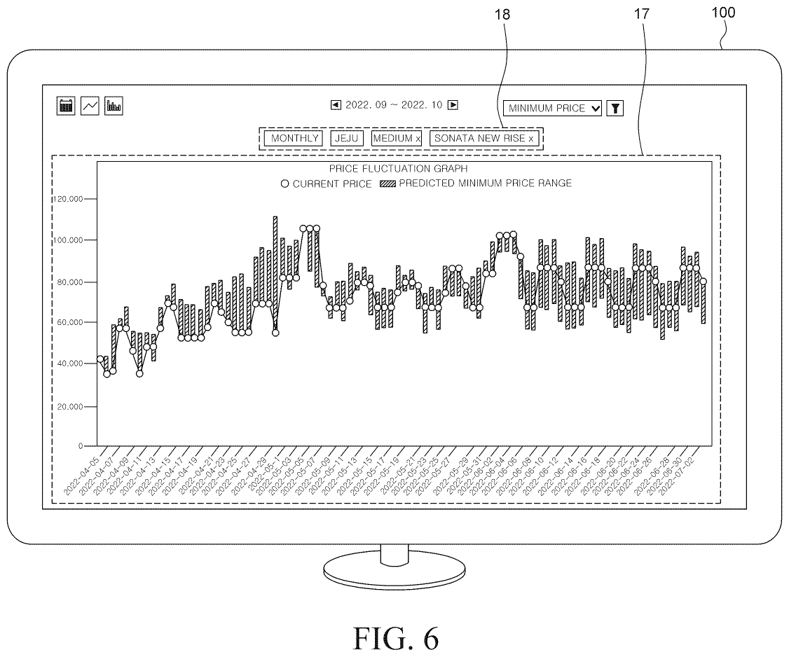

In relation to this, FIG. 6 is an exemplary view of a price prediction service interface screen provided through customer devices and seller devices according to one embodiment of this invention.

Referring to FIG. 6, the price prediction service interface screen can be configured to display changes in sales prices by usage start date according to product purchase as a line graph 17 for the period from the current time when the price query data was received until before the purchasable time. More specifically, line graph 17 can display the case of purchasing the product at the current time as a reference point for sales price. Additionally, line graph 17 can display the range of sales price variations by date until the usage start time as a bar graph on the reference point.

For example, the price prediction service interface screen can show predicted sales prices for when the product available for use from Apr. 5, 2022 to Jul. 2, 2022 would be purchased in the future, at the time when price query data was received on Apr. 5, 2022 (current time). As one example, a product usable on May 11, 2022, costs 67,000 won if purchased at the current time, and if purchased in the future, the sales price is predicted to be between 60,000 won and 80,000 won. In other words, according to processor 140's prediction, the price may fluctuate from the current time until May 11, 2022, and can be understood to potentially drop to a minimum of 60,000 won or rise to a maximum of 80,000 won. In another example, since the bar graph does not go below the current sales price from the current time until May 5, 2022 except for some parts, processor 140 can suggest purchase at the current time based on this.

In various embodiments, processor 140 can provide judgment results about promotional sales prices. For example, processor 140 can receive purchase links including product sales conditions and sales prices from customer device 200, and processor 140 can provide judgment results about whether the sales price is reasonable. For example, in the case of Jun. 16, 2022, while it costs 85,000 won if purchased at the current time, the future minimum price is predicted to be 70,000 won. If customer device 200 provides a purchase link for a special price product at 75,000 won, processor 140 can provide judgment results about whether this sales price is reasonable.

In this way, processor 140 can provide prediction results of sales prices by usable date when purchasing today, tomorrow, . . . , n days later, that is, combining the following two graphs.

Furthermore, the price prediction service interface screen can be configured to display price changes with multiple product condition data 18 selectively applied according to the product type. For example, customer device 100 can also check sales price change graphs with multiple product condition data 18 like “Jeju, medium-size, Sonata New Rise” added/excluded in rental car products.

Up to now, the price prediction server according to one embodiment of this invention has been explained. According to this invention, it can help customers make rational product purchases by providing predicted sales prices by purchase date for products with volatile pricing where consumer prices are not fixed.

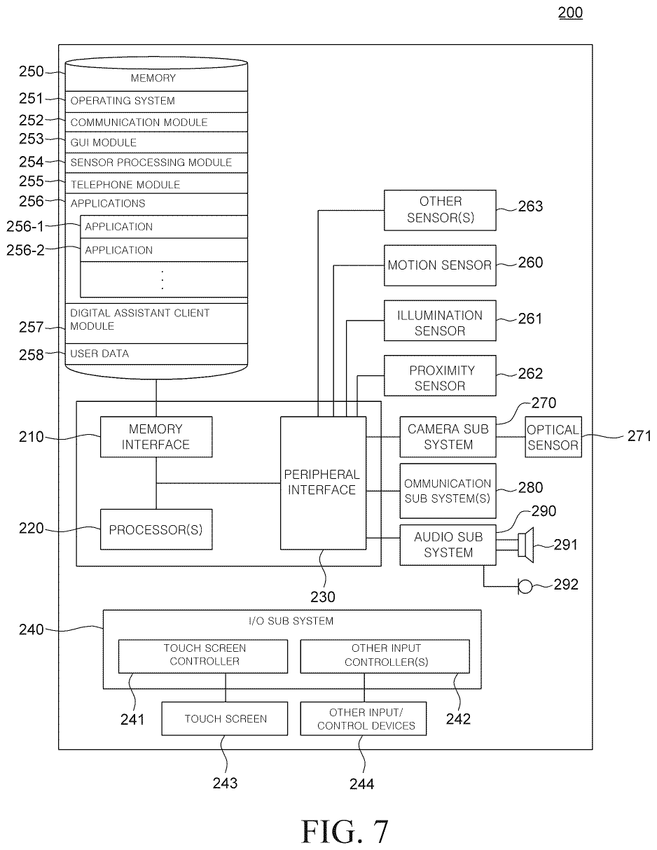

Below, referring to FIG. 7, the customer device 200 outputting the user interface screen for price prediction service will be explained.

FIG. 7 is a block diagram showing the configuration of a customer device according to one embodiment of this invention.

Referring to FIG. 7, customer device 200 may include memory interface 210, one or more processors 220, and peripheral interface 230. Various components within customer device 200 can be connected by one or more communication buses or signal lines.

Memory interface 210 can be connected to memory 250 and transfer various data to processor 220. Here, memory 250 can include storage media of at least one type among flash memory type, hard disk type, multimedia card micro type, card type memory (e.g., SD or XD memory), RAM, SRAM, ROM, EEPROM, PROM, network storage, cloud, blockchain database.

In various embodiments, memory 250 can store web/app applications for providing price prediction service, configuration data for price prediction service interface screens. Also, memory 250 can store customer's price query data for any product, customer's product purchase history, etc.

In various embodiments, memory 250 can store at least one among operating system 251, communication module 252, graphical user interface module (GUI) 253, sensor processing module 254, phone module 255, and application module 256. Specifically, operating system 251 can include instructions for processing basic system services and instructions for performing hardware tasks. Communication module 252 can communicate with at least one among other devices, computers, and servers. Graphical user interface module (GUI) 253 can process graphical user interfaces. Sensor processing module 254 can process sensor-related functions (for example, processing voice input received through one or more microphones 292). Phone module 255 can process phone-related functions. Application module 256 can perform various functions of user applications, such as electronic messaging, web browsing, media processing, navigation, imaging, and other process functions. Additionally, user device 100 can store one or more software applications 256-1, 256-2 (e.g., price prediction service application) associated with any one type of service in memory 250.

In various embodiments, memory 250 can store digital assistant client module 257 (hereinafter referred to as DA client module) and accordingly store instructions and various user data 258 (e.g., user-customized vocabulary data, preference data, other data such as user's electronic address book) for performing client-side functions of digital assistant.

Meanwhile, DA client module 257 can acquire user's voice input, text input, touch input and/or gesture input through various user interfaces (e.g., I/O subsystem 240) equipped in customer device 200.

Also, DA client module 257 can output data in audiovisual, tactile forms. For example, DA client module 257 can output data consisting of at least two combinations among voice, sound, alerts, text messages, menus, graphics, videos, animations, and vibrations. Additionally, DA client module 257 can communicate with digital assistant server (not shown) using communication subsystem 280.

In various embodiments, DA client module 257 can collect additional information about customer device 200's surroundings from various sensors, subsystems, and peripheral devices to construct context associated with user input. For example, DA client module 257 can provide context information along with user input to digital assistant server to infer user's intention. Here, context information that can accompany user input can include sensor information, for example, lighting, ambient noise, ambient temperature, images of surroundings, video, etc. In another example, context information can include physical state of customer device 200 (e.g., device orientation, device location, device temperature, power level, speed, acceleration, motion patterns, cellular signal strength, etc.). In yet another example, context information can include information related to software state of customer device 200 (e.g., running processes, installed programs, past and current network activity, background services, error logs, resource usage, etc.).

In various embodiments, memory 250 can include instructions that are added or deleted, and furthermore, customer device 200 can include additional configurations beyond those shown in FIG. 7, or exclude some configurations.

Processor 220 can control the overall operation of customer device 200 and can execute various commands to implement user interfaces that can check predicted product prices by date through driving applications or programs stored in memory 250.

Processor 220 can correspond to computing devices such as CPU (Central Processing Unit) or AP (Application Processor). Also, processor 220 can be implemented in the form of an integrated chip (IC) such as SoC (System on Chip) which integrates various computing devices including devices like NPU (Neural Processing Unit) that perform machine learning.

In various embodiments, processor 220 can transfer price query data to price prediction server 100 and output a user interface screen that visualizes predicted daily sales prices based on this. Here, the user interface screen can include a line graph showing changes in sales prices by purchase date during the period from the current time when the customer requested the price prediction service until before the purchasable time. And if the line graph is the sales price reference point at the current time, additionally, the range of sales prices that change by date until the usage start time can be displayed as a bar graph on the reference point. Besides this, processor 220 can output different sales prices by product condition according to user (customer) interaction.

Peripheral interface 230 can provide data by connecting with various sensors, subsystems, and peripheral devices to enable customer device 200 to perform various functions. Here, when customer device 200 performs any function, it can be understood as being performed by processor 220.

Peripheral interface 230 can receive data from motion sensor 260, light sensor (optical sensor) 261, and proximity sensor 262, and through this, customer device 200 can perform functions such as orientation, light, and proximity sensing. In another example, peripheral interface 230 can receive data from other sensors 263 (positioning system-GPS receiver, temperature sensor, biometric sensor) and through this, customer device 200 can perform functions related to other sensors 263.

In various embodiments, customer device 200 can include camera subsystem 270 connected to peripheral interface 230 and optical sensor 271 connected to this, and through this, customer device 200 can perform various photography functions such as photo taking and video clip recording.

In various embodiments, customer device 200 can include communication subsystem 280 connected to peripheral interface 230. Communication subsystem 280 consists of one or more wired/wireless networks and can include various communication ports, radio frequency transceivers, optical transceivers.

In various embodiments, customer device 200 can include audio subsystem 290 connected to peripheral interface 230, and this audio subsystem 290 includes one or more speakers 291 and one or more microphones 292, enabling customer device 200 to perform voice-operated functions such as voice recognition, voice replication, digital recording, and telephone functions.

In various embodiments, customer device 200 can include I/O subsystem 240 connected to peripheral interface 230. For example, I/O subsystem 240 can control touch screen 243 included in customer device 200 through touch screen controller 241.

For example, touch screen controller 241 can detect user's contact and movement or interruption of contact and movement using any one of multiple touch sensing technologies such as capacitive, resistive, infrared, surface acoustic wave technology, proximity sensor arrays, etc. In another example, I/O subsystem 240 can control other input/control devices 244 included in customer device 200 through other input controller(s) 242. As one example, other input controller(s) 242 can control one or more buttons, rocker switches, thumb-wheel, infrared port, USB port, and pointer devices such as stylus.

Up to now, customer device 200 using the price prediction service according to this invention has been explained. According to this invention, it can help customers easily select product options (conditions) by providing different sales price graphs by product condition through the price prediction service interface.

Although embodiments of this invention have been described in more detail with reference to the accompanying drawings, this invention is not necessarily limited to such embodiments and can be variously implemented within the scope that does not deviate from the technical idea of this invention. Therefore, the embodiments disclosed in this invention are not for limiting the scope of this invention's technical idea but for explaining it, and the scope of this invention's technical idea is not limited by these embodiments. Therefore, it should be understood that the above-described embodiments are exemplary in all aspects and not limiting. The scope of protection of this invention should be interpreted by the following claims, and it should be interpreted that all technical ideas within equivalent scope are included in the rights scope of this invention.

1. A product price prediction method performed by a processor of a price prediction server, comprising:
receiving price query data for a product from a customer device through a communication interface operatively connected to the processor;
generating multiple product condition data from the price query data based on predetermined multiple features for the product;
predicting sales prices by purchase date by inputting the multiple product condition data into a price prediction model trained to predict product sales prices by purchase date using product condition data as input; and
providing the customer device with a price prediction service interface screen that visualizes the product's sales prices graphically by purchase date.

2. The method of claim 1, wherein
the price query data includes at least one of: product identification information, product purchasable dates, usage start date, usage end date, usage time, and product type-specific options.

3. The method of claim 2, wherein
the generating step further includes:
converting the query date and usage start date included in the price query data into data including usage year, usage week number of the year, usage day of week, day before holiday, holiday duration, day after holiday, and advance purchase days, according to the product type.

4. The method of claim 2, wherein
the price prediction service interface screen is configured to display changes in sales prices by purchase date as a line graph for the period from the current time when the price query data was received until before the purchasable time.

5. The method of claim 4, wherein
the price prediction service interface screen is configured to:
display the case of purchasing the product at the current time as a reference point for the sales price, and
display the range of predicted future sales prices by date until the usage start time as a bar graph on the reference point.

6. The method of claim 4, wherein
the price prediction service interface screen is configured to display price changes with multiple product condition data selectively applied according to the product type.

7. The method of claim 1, wherein
the multiple features include at least one data among: customer inquiry date, usage date/time, usage location, product type, seller type, and customer rating data.

8. The method of claim 1, wherein
when one type of product condition data includes at least two options, the price prediction model is separately learned into first, second, and third price prediction models using:
a first product condition dataset containing only one option,
a second product condition dataset containing only the other option, and
a third product condition dataset containing none of the options.

9. A price prediction server comprising:
a communication interface;
memory; and
a processor operatively connected to the communication interface and the memory,
wherein the processor is configured to:
receive price query data for a product from a customer device through the communication interface,
generate multiple product condition data from the price query data based on predetermined multiple features for the product,
predict sales prices by purchase date by inputting the multiple product condition data into a price prediction model trained to predict product sales prices by purchase date using product condition data as input, and
provide the customer device with a price prediction service interface screen that visualizes the product's sales prices graphically by purchase date.

10. The server of claim 9, wherein
the price query data includes at least one of: product identification information, product purchasable dates, usage start date, usage end date, usage time, and product type-specific options.

11. The server of claim 10, wherein
the processor is further configured to:
convert the query date and usage start date included in the price query data into data including usage year, usage week number of the year, usage day of week, day before holiday, holiday duration, day after holiday, and advance purchase days, according to the product type.

12. The server of claim 10, wherein
the price prediction service interface screen is configured to display changes in sales prices by purchase date as a line graph for the period from the current time when the price query data was received until before the purchasable time.

13. The server of claim 12, wherein
the price prediction service interface screen is configured to:
display the case of purchasing the product at the current time as a reference point for the sales price, and
display the range of predicted future sales prices by date until the usage start time as a bar graph on the reference point.

14. (canceled)

15. The server of claim 9, wherein
the multiple features include at least one data among: customer inquiry date, usage date/time, usage location, product type, seller type, and customer rating data.

16. The server of claim 9, wherein
when one type of product condition data includes at least two options, the price prediction model is separately learned into first, second, and third price prediction models using:
a first product condition dataset containing only one option,
a second product condition dataset containing only the other option, and
a third product condition dataset containing none of the options.
